(19) United States
(12) Patent Application Publication
(10) Pub. No.: US 2015/0192087 A1
(43) Pub. Date: Jul. 9, 2015

(54) FUEL INJECTION CONTROL DEVICE OF DIESEL ENGINE

(71) Applicant: Mazda Motor Corporation, Aki-gun (JP)

(72) Inventors: Naotoshi Shirahashi, Hiroshima-shi (JP); Takeshi Matsubara, Aki-gun (JP); Yuki Sobatani, Takarazuka-shi (JP); Takuya Ohura, Higashihiroshima-shi (JP); Takeshi Inazumi, Hiroshima-shi (JP)

(21) Appl. No.: 14/579,788

(22) Filed: Dec. 22, 2014

(30) Foreign Application Priority Data
Jan. 9, 2014 (JP) 2014-002238

(51) Int. Cl. F02D 41/40; F02D 41/30; F02D 41/00

(52) U.S. Cl. CPC F02D 41/405; F02D 41/0057; F02D 41/0007; F02D 41/3035

(57) ABSTRACT

A fuel injection control device of a diesel engine is provided. The device includes an engine body, a fuel injection valve, a turbocharger, a low-pressure EGR system, and a controller for operating the engine body. Within a predetermined high engine-load operating range, the controller controls the fuel injection valve to operate the low-pressure EGR system and perform main and post injections. Within the operating range where the post injection is performed, when the engine load is lower than a predetermined load, an injection amount of the post injection is set to a first injection amount and an injection timing of the post injection is set to a first timing, and when the engine load is higher than the predetermined load, the injection amount of the post injection is set to a second injection amount and the injection timing of the post injection is set to a second timing.

### BACKGROUND

The present invention relates to a fuel injection control device of a diesel engine.

JP2002-195074A discloses an art relating to a fuel injection of a diesel engine, in which a post injection is performed after a main injection to reduce soot generated by a combustion caused from the main injection. JP2002-195074A also discloses an art relating to an injection timing of a post injection, in which when a load of the engine is high, the injection timing of the post injection is more retarded than when the engine load is medium, in other words, the injection timing of the post injection is shifted to separate from the main injection, so as to significantly reduce a generation amount of soot.

Meanwhile, the diesel engine disclosed in JP2002-195074A includes a high-pressure EGR system for extracting exhaust gas from a position of an exhaust passage upstream of a turbine of a turbocharger and introducing it to a position of an intake passage downstream of a compressor of the turbocharger. Since the high-pressure EGR system extracts the exhaust gas from the position of the exhaust passage upstream of the turbine, a speed of the turbocharger may accordingly decrease.

On the other hand, a low-pressure EGR system for extracting exhaust gas from a position of an exhaust passage downstream of a turbine of a turbocharger and introducing it to a position of an intake passage upstream of a compressor of the turbocharger has been known. With the low-pressure EGR system, even within an engine operating range where turbocharging is performed by the turbocharger, a large amount of exhaust gas can be introduced to the intake side. Thus, a combustion temperature can be reduced, which is advantageous in improving exhaust emission performance, particularly in reducing a discharge amount of NOx.

However, if the combustion temperature is low due to the introduction of the large amount of exhaust gas, retarding the injection timing of the post injection as disclosed in JP2002-195074A leads to reducing a temperature inside a cylinder at the injection timing of the post injection, and therefore, soot cannot be reduced sufficiently by the post injection. On the other hand, particularly when the engine load is high, soot generated by the main injection increases due to the increase of an injection amount of the main injection and the introduction of the large amount of exhaust gas through the low-pressure EGR system. For this reason, the present inventors noticed that the discharge amount of soot increases if the large amount of soot cannot be reduced sufficiently by the post injection. Such a disadvantage becomes obvious during an acceleration transition within an engine operating range where the engine load is high, because the turbocharging by the turbocharger delays during the acceleration transition and the responsiveness of the low-pressure EGR system to the change of the operating state of the engine is low.

### SUMMARY

The present invention is made in view of the above situations and reduces a discharge amount of soot when a load of a diesel engine provided with a low-pressure EGR system is high.

According to an aspect of the present invention, a fuel injection control device of a diesel engine is provided. The device includes an engine body having a cylinder, a fuel injection valve for injecting a fuel into the cylinder, a turbocharger having a turbine disposed in an exhaust passage of the engine body and a compressor disposed in an intake passage of the engine body, a low-pressure EGR system for introducing exhaust gas extracted from a position of the exhaust passage downstream of the turbocharger, into a position of the intake passage upstream of the turbocharger, and a controller for operating the engine body by controlling an injection mode of the fuel through the fuel injection valve, and the circulation of the exhaust gas through the low-pressure EGR system.

Further, when an operation state of the engine body is within a predetermined high engine-load operating range where turbocharging by the turbocharger is performed, the controller operates the low-pressure EGR system and controls the fuel injection valve to perform a main injection and a post injection after the main injection. Within the operating range where the post injection is performed, the controller performs a post-injection switching control in which when the engine load is lower than a predetermined load, an injection amount of the post injection is set to a first injection amount and an injection timing of the post injection is set to a first timing, and when the engine load is higher than the predetermined load, the injection amount of the post injection is set to a second injection amount that is less than the first injection amount, and the injection timing of the post injection is set to a second timing that is advanced than the first timing.

According to this configuration, when the operation state of the engine body is within the high engine-load operating range where the turbocharging by the turbocharger is performed, the low-pressure EGR system is operated. Thus, NOx can be reduced.

Moreover, by controlling the fuel injection valve to perform the post injection after the main injection, soot generated by the main injection is combusted by the post injection and a discharge amount of soot can also be reduced.

Further, with the above configuration, within the operating range where the post injection is performed, when the engine load is lower than the predetermined load, the injection amount of the post injection is set to the first injection amount and the injection timing of the post injection is set to the first timing. The first injection amount is a relatively large injection amount, and the first timing is a relatively retarded injection timing. When the engine load is lower than the predetermined load, since the engine load is low, the amount of soot generated by the main injection is small. Since there is no need to combust a large amount of soot by the post injection, the post injection is performed with a comparatively large injection amount at a timing far apart from the main injection. Thus, the remaining air and the fuel are sufficiently mixed with each other, and the combustion caused by the post injection can be stably performed. As a result, the generation of soot by the combustion from the post injection is suppressed while reducing the soot generated by the main injection, and the discharge amount of soot when the engine load is lower than the predetermined load can be reduced.

On the other hand, within the operating range where the post injection is performed, when the engine load is higher than the predetermined load, the injection amount of the post injection is set to the second injection amount, and the injection timing of the post injection is set to the second timing. The second injection amount is a relatively small injection amount, and the second timing is a relatively advanced injection timing. When the engine load is higher than the predetermined load, a large amount of soot may be generated by the main injection, and therefore, the soot needs to be sufficiently combusted by the post injection. Meanwhile, since the low-pressure EGR system is operated, if the injection timing of the post injection is retarded similarly to when the engine load is lower than the predetermined load as described above, the ignitability degrades due to a low temperature inside the cylinder at the injection timing, and the combustion by the post injection cannot be performed sufficiently. Therefore, when the engine load is higher than the predetermined load, the post injection is performed at a timing close to the main injection. In this manner, the fuel is injected into the cylinder while the temperature inside the cylinder is high, and thus, the ignitability can be increased. As a result, the combustion by the post injection can be performed sufficiently, and the large amount of generated soot can be sufficiently combusted. Moreover, when the engine load is higher than the predetermined load, by reducing the injection amount of the post injection according to the increased proximity of the timing of the post injection to the main injection, the generation of soot due to the post injection can be suppressed. Thus, the sufficient combustion of the large amount of soot generated by the main injection and the suppression of soot generated by the post injection, in combination with each other, reduce the discharge amount of soot when the engine load is higher than the predetermined load.

In the post-injection switching control, the controller may adjust the injection amount of the post injection according to an air excess ratio of mixture gas inside the cylinder. When the air excess ratio is higher than a predetermined value that is higher than 1, the injection amount of the post injection may be adjusted by being increased as the air excess ratio approaches the predetermined value so that the injection amount reaches its highest value when the air excess ratio is at the predetermined value, and when the air excess ratio is lower than the predetermined value, the injection amount of the post injection may be adjusted by being reduced as the air excess ratio approaches 1 so that the injection amount becomes zero when the air excess ratio is 1. The phrase “the air excess ratio” used here is an average air excess ratio within the cylinder.

When the air excess ratio of the mixture air inside the cylinder is 1, since the amount of air inside the cylinder is small, the combustion by the post injection cannot be performed sufficiently and, as a result, a sufficient soot reducing effect cannot be obtained. Therefore, when the air excess ratio is 1, by setting the injection amount of the post injection to zero, in other words, by not performing the post injection, an unnecessary fuel injection is avoided, and, as a result, degradation in fuel consumption and exhaust emission control performance can be prevented.

Moreover, considering that the amount of air inside the cylinder becomes relatively small, the injection amount of the post injection is generally reduced as the air excess ratio approaches 1; however, since the amount of soot generated by the main injection increases as the air excess ratio approaches 1, there is a demand to reduce the discharge amount of soot by the post injection as much as possible.

In this regard, the present inventors have found that when the air excess ratio (i.e., average air excess ratio) is higher than a predetermined value that is higher than 1, the soot reducing effect by the post injection can be obtained by utilizing air locally existing inside the cylinder. Therefore, it is preferable to correct the injection amount of the post injection by increasing it as the air excess ratio approaches the predetermined value so that the injection amount reaches its highest amount at the predetermined value that is higher than 1. In this manner, the discharge amount of soot can further be reduced when the air excess ratio is close to 1. On the other hand, since the soot reducing effect by the post injection can hardly be obtained when the air excess ratio becomes 1 as described above, when the air excess ratio is lower than the predetermined value, it is preferable to reduce the injection amount of the post injection toward zero as the air excess ratio approaches 1.

In the post-injection switching control, the controller may perform a pre-injection before the main injection. The controller may change an injection amount of the pre-injection corresponding to the change of the injection amount of the post injection.

In the case where at least the pre-injection, the main injection, and the post injection are performed as the fuel injections into the cylinder, when changing the injection amount of the post injection while fixing the total injection amount of the respective injections, it is preferable to change the injection amount of the pre-injection instead of the injection amount of the main injection. In this manner, the injection amount of the main injection that contributes in generating a torque is not changed, and therefore, reduction/increase of the torque can be avoided. Moreover, although the pre-injection contributes in igniting of the mixture gas, since the injection amount thereof is larger than that of the post injection, even when the injection amount of the pre-injection is changed corresponding to the change of the injection amount of the post injection, the change rate of the injection amount of the pre-injection becomes small, which means the influence on the ignitability of the mixture gas is small.

The controller may perform the post-injection switching control when the engine body is in an acceleration transition.

In other words, during the acceleration transition in which the turbocharging by the turbocharger is delayed, soot is generally generated more easily because a turbocharging pressure falls below a target pressure; however, by performing the post-injection switching control described above, the discharge of soot can be suppressed when the engine load is higher than the predetermined load and when the engine load is lower than the predetermined load.

The controller may perform the post-injection switching control when the engine body is during the acceleration transition and the air excess ratio of the mixture gas inside the cylinder is lower than the predetermined value.

As described above, the low-pressure EGR system introduces the exhaust gas extracted from the position of the exhaust passage downstream of the turbocharger, into the position of the intake passage upstream of the turbocharger. Therefore, the responsiveness of the low-pressure EGR system to the change of the operation state of the engine is low. Therefore, by performing the post-injection switching control, with consideration to both the air excess ratio of the mixture gas inside the cylinder relating to the responsiveness of the low-pressure EGR system and to the turbocharging delay of the turbocharger described above, the discharge of soot can effectively be suppressed.

### BRIEF DESCRIPTION OF THE DRAWINGS

FIG. 1 is a view schematically illustrating a configuration of a diesel engine and a configuration of an engine system according to one embodiment.

FIG. 2 is one example of a map relating to an operation control of the engine.

FIG. 3 is a view illustrating one example of a fuel injection mode within a predetermined operating range.

FIG. 4 is a composite chart, in which Part (A) illustrates a relationship among an injection amount and injection timing of an after injection and a discharge amount of soot within a low engine load range, and Part (B) illustrates a relationship among the injection amount and injection timing of the after injection and the discharge amount of soot within a high engine load range.

FIG. 5 is a flowchart relating to a fuel injection control during an acceleration transition.

FIG. 6 is a map for setting a threshold of a turbocharging pressure relating to an acceleration determination.

FIG. 7 is a map for setting a threshold of λ relating to an EGR determination.

FIG. 8 is a chart illustrating a base correction amount of the injection amount of the after injection with respect to an engine speed.

FIG. 9 is a chart illustrating one example of a change tendency of the injection amount of the after injection after a correction regarding an air excess ratio is performed.

FIG. 10 is a chart for comparing a discharge amount of soot between a case where a correction of the injection amount of the after injection is performed according to the air excess ratio and a case where the correction is not performed.

### DETAILED DESCRIPTION OF EMBODIMENT

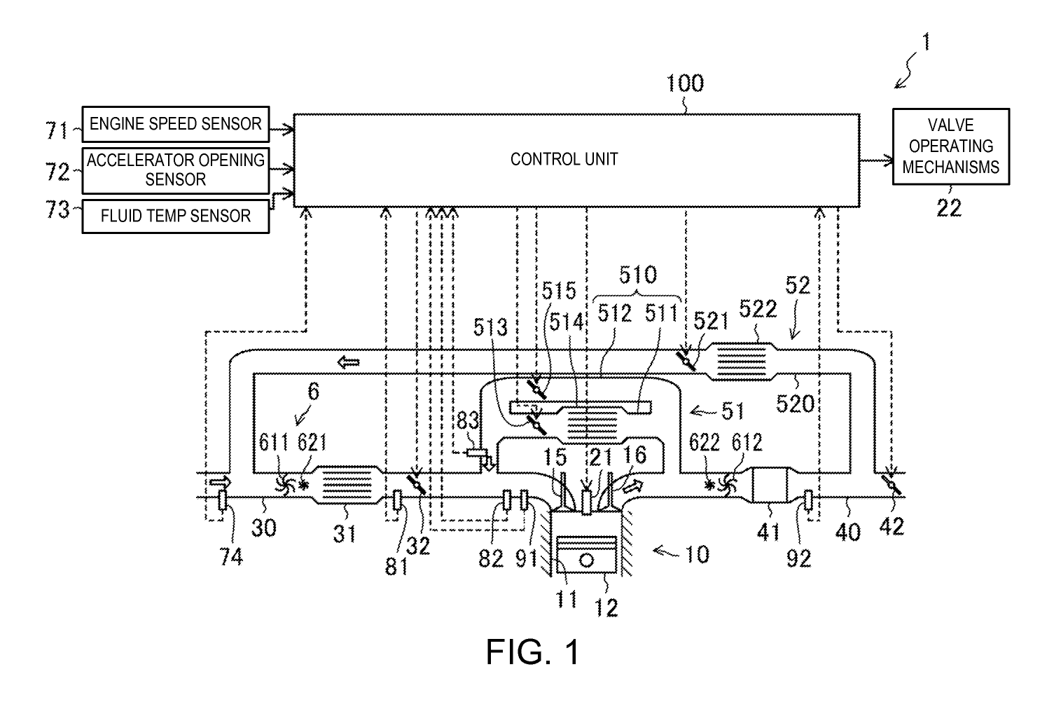

Hereinafter, one embodiment of a fuel injection control device of a diesel engine is described with reference to the appended drawings. The following description is an illustration. FIG. 1 is a view schematically illustrating a configuration of a diesel engine and a configuration of an engine system 1 according to this embodiment. The engine system 1 is a system of the diesel engine installed in a vehicle and is supplied a fuel mainly containing diesel fuel.

An engine body (hereinafter, simply referred to as the engine) 10 has a plurality of cylinders 11 (only one is illustrated in FIG. 1). In each cylinder 11, a piston 12 coupled to a crankshaft (not illustrated) is inserted and an injector 21 for injecting the fuel into the cylinder 11 is provided.

In the engine 10, an intake port and an exhaust port are formed for each cylinder 11, and an intake valve 15 for opening and closing the intake port is disposed to each intake port and an exhaust valve 16 for opening and closing the exhaust port is disposed to each exhaust port. A valve system for operating the intake and exhaust valves 15 and 16 is provided with valve operating mechanisms 22 for at least changing the opening timings of the intake and exhaust valves 15 and 16.

The intake ports of the respective cylinders 11 are communicated to an intake passage 30 via an intake manifold (not expressly indicated in FIG. 1). Moreover, the exhaust ports of the respective cylinders 11 are communicated to an exhaust passage 40 via an exhaust manifold (not expressly indicated in FIG. 1).

In the intake passage 30, a large compressor 611 and a small compressor 621 of a turbocharging system 6, an intercooler 31 for cooling air compressed by the compressors 611 and 621, and a throttle valve 32 for adjusting an intake air amount into the cylinders 11 are disposed in this order from the upstream side to the downstream side.

In the exhaust passage 40, a small turbine 622 and a large turbine 612 of the turbocharging system 6, an exhaust gas purification system 41 including an oxidative catalyst for purifying a hazardous component within the exhaust gas and a diesel particulate filter (DPF) for capturing particulate matters within the exhaust gas, and an exhaust shutter valve 42 are disposed in this order from the upstream side to the downstream side.

A part of the intake passage 30 downstream of the small compressor 621 (more specifically, a part downstream of the throttle valve 32) is connected to a part of the exhaust passage 40 upstream of the small turbine 622 by a high-pressure EGR passage 510 for circulating a part of the exhaust gas to the intake passage 30. The high-pressure EGR passage 510 includes a main passage 511 and a cooler bypass passage 512 formed in parallel to the main passage 511. The main passage 511 is provided with a high-pressure EGR valve 513 for adjusting a circulation amount of the exhaust gas to the intake passage 30 and an EGR cooler 514 for cooling the exhaust gas. The cooler bypass passage 512 is provided with a cooler bypass valve 515 for adjusting a flow rate of the exhaust gas flowing inside the cooler bypass passage 512. The high-pressure EGR passage 510, the high-pressure EGR valve 513, the cooler bypass valve 515, and the EGR cooler 514 configure a high-pressure EGR system 51.

Moreover, a part of the intake passage 30 upstream of the large compressor 611 is connected to a part of the exhaust passage 40 downstream of the large turbine 612 (more specifically, between the exhaust gas purification device 41 and the exhaust shutter valve 42) by a low-pressure EGR passage 520 for circulating a part of the exhaust gas to the intake passage 30. The low-pressure EGR passage 520 is provided with a low-pressure EGR valve 521 for adjusting a circulation amount of the exhaust gas to the intake passage 30 and an EGR cooler 522 for cooling the exhaust gas.

The exhaust shutter valve 42 is disposed in the exhaust passage 40, downstream of the connecting position with the low-pressure EGR passage 520. The exhaust shutter valve 42 is a flow rate adjusting valve and an opening thereof is adjustable. When the opening of the exhaust shutter valve 42 is reduced, the flow rate of the exhaust gas passing therethrough is reduced and a pressure within the low-pressure EGR passage 520 can be relatively increased on the exhaust passage 40 side compared to the intake passage 30 side. The low-pressure EGR passage 520, the low-pressure EGR valve 521, the EGR cooler 522, and the exhaust shutter valve 42, configure a low-pressure EGR system 52.

The turbocharging system 6 is configured with two-stage turbochargers having a large turbocharger and a small turbocharger. The large turbocharger is relatively large and the small turbocharger is relatively small.

The large turbocharger has the large compressor 611 disposed in the intake passage 30 and the large turbine 612 disposed in the exhaust passage 40, and although it is not illustrated in FIG. 1, the large compressor 611 is coupled to the large turbine 612.

The small turbocharger has the small compressor 621 disposed in the intake passage 30 and the small turbine 622 disposed in the exhaust passage 40, and although it is not illustrated in FIG. 1, the small compressor 621 is coupled to the small turbine 622. In the intake passage 30, the small compressor 621 is disposed downstream of the large compressor 611. In the exhaust passage 40, the small turbine 622 is disposed upstream of the large turbine 612. In other words, in the intake passage 30, the large compressor 611 and the small compressor 621 are aligned in this order from the upstream side. In the exhaust passage 40, the small turbine 622 and the large turbine 612 are aligned in this order from the upstream side. These large and small turbines 612 and 622 are rotated by the exhaust gas flow, and thus, the large and small compressors 611 and 621 are operated.

Note that, although it is not illustrated in FIG. 1, the intake passage 30 is connected with an intake bypass passage for bypassing the small compressor 621. A bypass valve for adjusting an amount of gas flowing in the intake bypass passage is disposed in the intake bypass passage. On the other hand, the exhaust passage 40 is connected with a small exhaust bypass passage for bypassing the small turbine 622 and a large exhaust bypass passage for bypassing the large turbine 612. A regulating valve for adjusting an amount of gas flowing in the small exhaust bypass passage is disposed in the small exhaust bypass passage, and a wastegate valve for adjusting an amount of gas flowing in the large exhaust bypass passage is disposed in the large exhaust bypass passage.

The reference numeral “100” indicates a control unit for controlling the engine system 1. A control unit 100 is a controller based on a well-known microcomputer, and it includes a central processing unit (CPU) for executing a program, a memory comprised of, for example, a RAM and a ROM, for storing the program and data, and an input/output (I/O) bus for inputting and outputting electric signals.

The control unit 100 is connected with sensors including an engine speed sensor 71 for detecting a speed of the engine 10, an accelerator opening sensor 72 for detecting an accelerator opening, and a fluid temperature sensor 73 for detecting a temperature of cooling water (coolant) of the engine 10.

An airflow sensor 74 for detecting a flow rate (and temperature) of fresh air flowing in the intake passage 30 is disposed on the intake passage 30, and the airflow sensor 74 outputs the detected flow rate and the detected fresh air temperature (outer air temperature) to the control unit (see the dashed arrow in FIG. 1).

Moreover, temperature sensors for detecting temperatures and pressure sensors for detecting pressures are disposed at predetermined positions of the intake passage 30, the exhaust passage 40, the high-pressure EGR passage 510, and the low-pressure EGR passage 520. Each sensor is connected to the control unit 100, and its detection value is outputted to the control unit 100 (see the dashed arrows in FIG. 1).

Here, the temperature sensors include a sensor 81 for detecting a gas temperature at a position of the intake passage 30 downstream of the intercooler 31, a sensor 82 for detecting a gas temperature within the intake manifold, and a sensor 83 for detecting a gas temperature within the high-pressure EGR passage 510. Moreover, the pressure sensors include a sensor 91 for detecting a pressure within the intake manifold (i.e., intake air pressure sensor). Further, an 02 sensor 92 for detecting an oxygen concentration within the exhaust gas is disposed downstream of the exhaust gas purification system 41, and the 02 sensor 92 also outputs its detection value to the control unit 100.

Then, the control unit 100 determines an operating state of the engine 10 based on the signals from the respective sensors and the like described above, and at least controls the injectors 21, the valve operating mechanisms 22, the throttle valve 32, the exhaust shutter valve 42, the high-pressure EGR valve 513, the cooler bypass valve 515, and the low-pressure EGR valve 521.

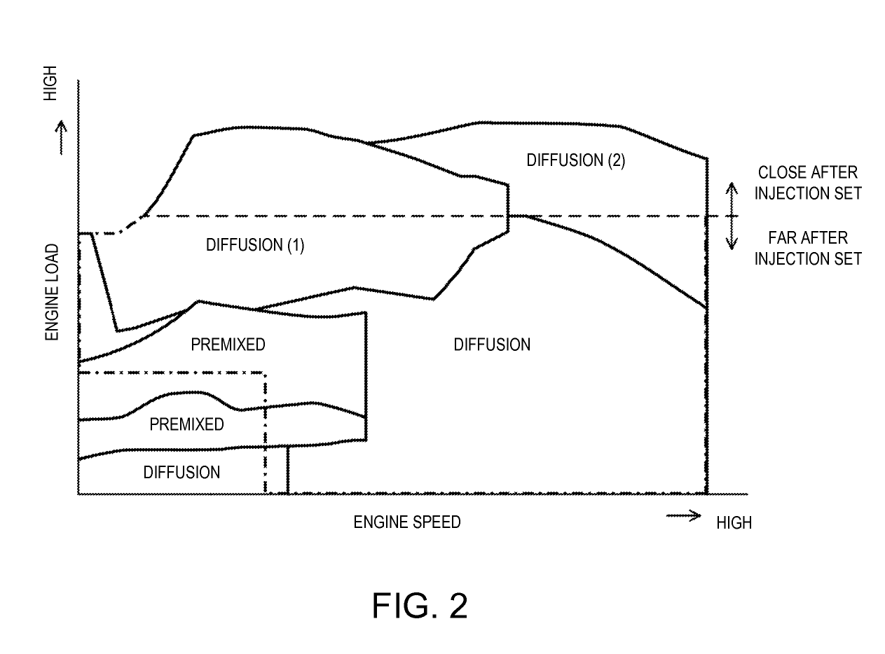

FIG. 2 is one example of a map relating to an operation control of the engine 10. The map is mainly related to an injection mode of the fuel through the injector 21, and the map is divided into a plurality of ranges based on the engine speed and an engine load. Each range is assigned an individual fuel injection mode. Among the plurality of ranges, within ranges where the engine speed is low and the engine load is low or medium (except for a range with a light engine load), a premixed combustion in which the fuel is injected into the cylinder 11 at a comparatively early timing and the fuel is combusted near a compression top dead center (CTDC) is performed. Within all the ranges other than the ranges where the premixed combustion is performed, a diffusion combustion is performed, in which a main injection that contributes in generating a torque is performed near the CTDC.

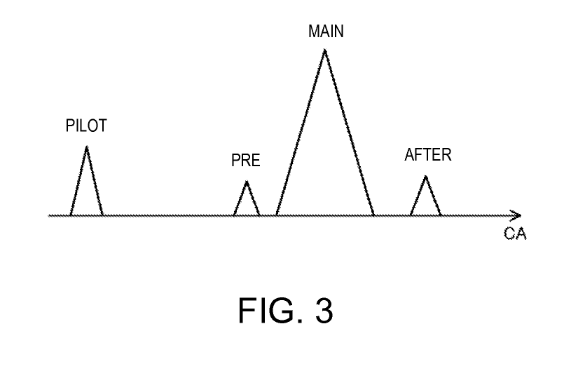

FIG. 3 is a view illustrating one example of a fuel injection mode, in other words, a fuel injection timing and a fuel injection amount. The fuel injection mode corresponds to a fuel injection mode within ranges where the engine load is high ((1) and (2)) in the map of FIG. 2. Within these ranges (1) and (2), four fuel injections of a pilot injection, a pre-injection, the main injection, and an after injection are performed in this order. Among these injections, the pilot injection and the pre-injection as a whole may alternatively be referred to as a preceding injection, and the after injection may alternatively be referred to as a post injection. The preceding injection is performed before the main injection and the post injection is performed after the main injection. The pilot injection and the pre-injection mainly contribute in igniting the fuel injected by the main injection. The main injection mainly contributes in generating the torque. The after injection mainly contributes in combusting soot generated by the combustion caused from the main injection and reducing a discharge amount of soot. Note that, the injection amount of each injection is different between the ranges (1) and (2).

Moreover, although it is not illustrated, the small turbocharger and/or the large turbocharger are operated substantially within all the ranges in the map of FIG. 2. Further, the exhaust gas is introduced into the intake passage 30 by a high-pressure EGR system 51 and/or the low-pressure EGR system 52 in substantially all the operating ranges of the engine 10. Note that, an introduction amount of the exhaust gas is changed based on the operating state of the engine 10. Particularly within the ranges where the engine load is relatively high, the exhaust gas is introduced into the intake passage 30 through the low-pressure EGR system 52. The low-pressure EGR system 52 extracts the exhaust gas from a position of the exhaust passage 40 downstream of the turbines 612 and 622 and introduces the exhaust gas into the intake passage 30. Thus, the exhaust gas can be circulated without reducing a speed of the turbochargers. In one operating state of the engine 10, the turbocharging system 6, and the high-pressure and low-pressure EGR systems 51 and 52 are all operated, and within the high engine load ranges (1) and (2), the turbocharging system 6 and the low-pressure EGR system 52 are operated.

By circulating the exhaust gas even within the high engine load ranges, a combustion temperature is reduced, which is advantageous in reducing NOx. On the other hand, because the injection amount of the main injection (which, hereinafter, may simply be referred to as the main injection amount) is increased as the engine load becomes higher, and the exhaust gas is circulated, a large amount of soot may be generated due to the combustion caused by the main injection. Therefore, the large amount of generated soot needs to be combusted sufficiently by causing a combustion with the after injection.

Here, as described above, reducing the combustion temperature by the circulation of the exhaust gas is disadvantageous in stabilizing the combustion caused by the after injection. In other words, if an injection timing of the after injection (which, hereinafter, may simply be referred to as the after injection timing) is set far apart from that of the main injection, a temperature inside the cylinder 11 at the after injection timing becomes low, and therefore, the combustion caused by the after injection becomes unstable and soot generated by the main injection cannot be reduced sufficiently.

Such a disadvantage becomes obvious during an acceleration transition within the high engine load ranges (1) and (2) because the turbocharging by the turbocharging system 6 delays and also because the responsiveness of the low-pressure EGR system 52 to the change of the operating state of the engine is low. However, when the engine load is relatively low within the ranges (1) and (2), the amount of soot generated by the main injection is originally small, and therefore, a demand to sufficiently reduce the large amount of soot by causing the combustion with the after injection is low.

Thus, with the engine system 1, during the acceleration transition within the engine high load ranges, an after-injection switching control (post-injection switching control) for changing the fuel injection mode, particularly the injection amount and injection timing of the after injection, according to the engine load is performed. Specifically, within a low engine load part of the engine high load ranges where the engine load is lower than a predetermined load indicated by the dashed line in the map of FIG. 2, the injection amount of the after injection (which, hereinafter, may simply be referred to as the after injection amount) is set to a first injection amount which is relatively large, and the after injection timing is set to a first injection timing which is relatively retarded. This injection mode of the after injection is referred to as a far after injection set, since an interval between the after injection and the main injection is long. On the other hand, within a high engine load part of the engine high load ranges where the engine load is higher than the predetermined load, the after injection amount is set to a second injection amount which is relatively small, and the after injection timing is set to a second injection timing which is relatively advanced. This injection mode of the after injection is referred to as a close after injection set, since the interval between the after injection and the main injection is short.

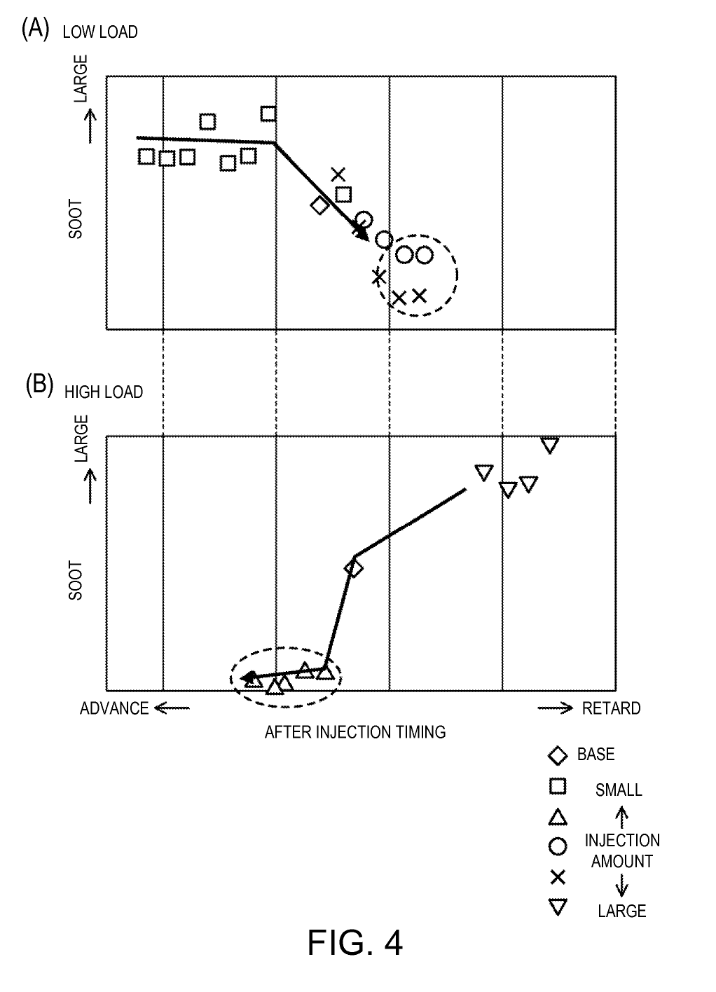

FIG. 4 is a composite chart, in which Part (A) illustrates a relationship among the injection amount and injection timing (i.e., injection start timing) of the after injection and the discharge amount of soot within the low engine load part lower than the predetermined load (the load indicated by the dashed line in the map of FIG. 2), and Part (B) illustrates a relationship among the injection amount and injection timing of the after injection and the discharge amount of soot within the high engine load part higher than the predetermined load. Each horizontal axis in Parts (A) and (B) indicates a crank angle, and the crank angles connected to each other between Parts (A) and (B) by the dashed line indicate the same crank angle.

First, from Part (B) of FIG. 4, it can be understood that within the high engine load part, when the after injection timing is relatively retarded and the injection amount is large, the discharge amount of soot increases, whereas, by advancing the after injection timing and reducing the after injection amount, the discharge amount of soot is reduced (see the arrow in Part (B)).

The reason why the discharge amount of soot is reduced can be considered as follows. As described above, since the combustion temperature is low due to the circulation of the exhaust gas, if the after injection timing is retarded, the in-cylinder temperature at the after injection timing becomes low, and as a result, the combustion caused by the after injection becomes unstable and the soot generated by the main injection cannot be combusted sufficiently, whereas, when the after injection timing is advanced, the fuel is injected while the in-cylinder temperature is comparatively high, and therefore, the combustion can be stabilized, and the large amount of soot generated by the main injection can be combusted sufficiently. Moreover, since the after injection timing is close to that of the main injection, generally, if the after injection amount is excessively large, the amount of soot increases due to the after injection; however, by reducing the after injection amount, the generation of soot due to the after injection is suppressed. Thus, it can be considered that within the high engine load part, by relatively advancing the after injection timing and relatively reducing the after injection amount, the reduction of soot generated by the main injection and the suppression of soot generated by the after injection, in combination with each other, reduce the discharge amount of soot.

While the high engine load part is as described above, within the low engine load part in Part (A) of FIG. 4, it can be understood that if the after injection timing is relatively advanced and the injection amount is small, the discharge amount of soot increases, whereas, by relatively retarding the after injection timing and increasing the after injection amount, the discharge amount of soot is reduced (see the arrow in Part (A)).

The reason why the discharge amount of soot is reduced can be considered as follows. As described above, within the low engine load part, since the amount of soot generated by the main injection is originally low, in view of reducing the discharge amount of soot, it is more effective to sufficiently reduce the soot generated by the after injection than combusting the soot by the after injection as much as possible. In other words, since the soot generation by the after injection increases if the after injection timing is advanced to be close to that of the main injection, by retarding the after injection timing to separate it from the main injection, the ignition delay of the after injection becomes longer and a period of time for the injected fuel to be sufficiently mixed with remaining air can be secured. As a result, the combustion by the after injection can be performed stably, and it can be considered that the soot generation by the after injection can also be suppressed while reducing the soot generated by the main injection.

The fuel injection timing and the fuel injection amount surrounded by the dashed line in Part (A) of FIG. 4 correspond to the far after injection set. Moreover, the fuel injection timing and the fuel injection amount surrounded by the dashed line in Part (B) of FIG. 4 correspond to the close after injection set. As is obvious from the comparison between Parts (A) and (B) of FIG. 4, the injection timing of the close after injection set is more advanced than the injection timing of the far after injection set. Moreover, the injection amount of the close after injection set (triangle marks) is smaller than the injection amount of the far after injection set (circle/cross marks).

Thus, during the acceleration transition, even when the four fuel injections of the pilot injection, the pre-injection, the main injection, and the after injection are performed while the operating state of the engine 10 is within either one of the ranges (1) or (2), the injection mode of the after injection is switched between the close after injection set and the far after injection set according to the engine load. In other words, at least the injection timing and injection amount of the after injection among the four fuel injections of the pilot injection, the pre-injection, the main injection, and the after injection are changed.

Note that, the selection of the far after injection set during the acceleration transition is not limited to the ranges (1) and (2) in the map of FIG. 2, and it may also be applied within the other ranges where the after injection is performed, which is surrounded by the dashed line and one-dot chain line in FIG. 2.

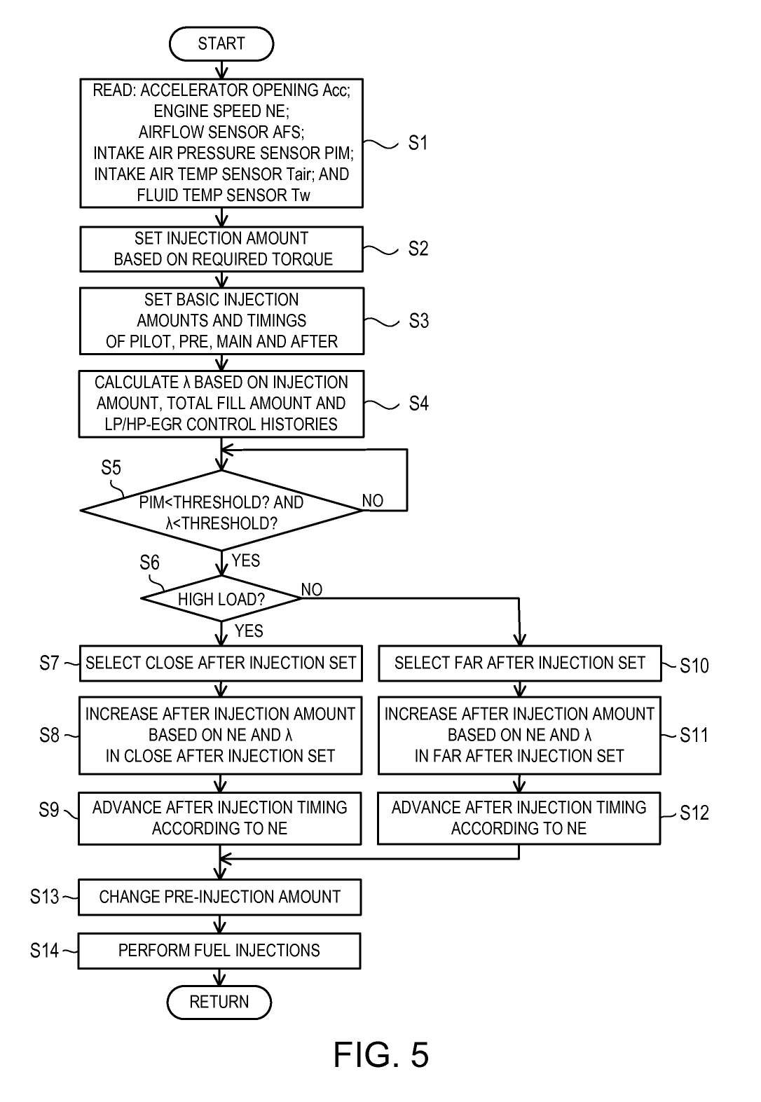

Next, a control of the engine system 1 during the acceleration transition is described with reference to the flowchart in FIG. 5. The control in the flowchart is performed by the control unit 100.

First, at S1 after the control is started, various signals are read. Specifically, although not limited to this, an accelerator opening Acc from the accelerator opening sensor 72, an engine speed NE from the engine speed sensor 71, a fresh air flow rate AFS from the airflow sensor 74, an intake air pressure (turbocharging pressure PIM) from the intake air pressure sensor 91, an intake air temperature Tair from the temperature sensor 82, and a coolant temperature Tw from the fluid temperature sensor 73, are read.

Next, at S2, a required torque is obtained based on the signals read at S1, and a total injection amount of the fuel is set based on the required torque. Then, at S3, the operating range of the map is determined based on the operating state of the engine 10, and the fuel injection mode is determined. In other words, when the operating range is either one of the ranges (1) or (2), injection amounts and injection timings of the pilot injection, the pre-injections, the main injection, and the after injection are set to respective basic injection amounts (i.e., injection amounts in a normal operation) and basic injection timings (i.e., injection timings in the normal operation).

At S4, an air excess ratio λ is calculated based on the total fuel injection amount, a total intake fill amount (containing fresh air and exhaust gas), and the control histories of the high-pressure and low-pressure EGR systems 51 and 52. Following S4, at S5, whether the engine 1 is during the acceleration transition or not is determined based on the measured turbocharging pressure PIM and the calculated air excess air ratio λ. Specifically, it is determined that the engine 1 is during the acceleration transition when the turbocharging pressure PIM is lower than a threshold and the air excess air ratio λ is smaller than a threshold. If the turbocharging pressure PIM is not lower than a threshold and the air excess air ratio is not smaller than a threshold, it is determined that the engine 1 is not during the acceleration transition.

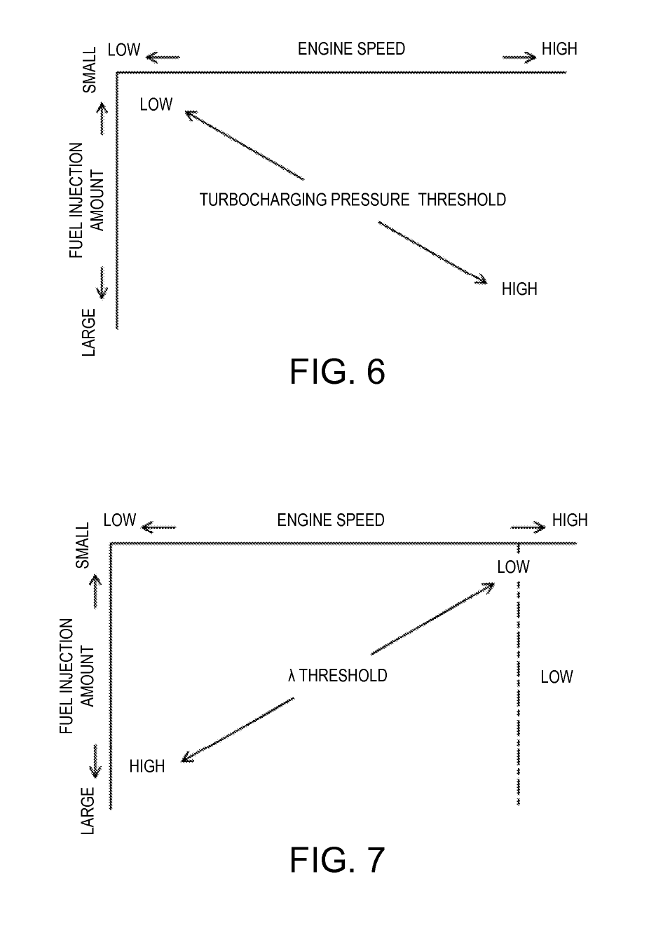

Here, FIG. 6 is a map for setting the threshold of the turbocharging pressure. The map is set and stored in the control unit 100 before use. The threshold of the turbocharging pressure is set based on the engine speed and the total fuel injection amount. The threshold of the turbocharging pressure is set higher as the engine speed is increased and the total fuel injection amount is increased, and the threshold is set lower as the engine speed is reduced and the total fuel injection amount is reduced. At S4, comparing the turbocharging pressure with the threshold corresponds to determining whether the turbocharging by the large turbocharger and/or the small turbocharger is delayed, and the turbocharging pressure being lower than the threshold means that the turbocharging is delayed and the turbocharging pressure suitable for the operating state of the engine 10 determined based on the engine speed and the total fuel injection amount is not obtained.

FIG. 7 is a map of setting the threshold of the air excess ratio λ. The map is also set and stored in the control unit 100 before use. The threshold of the air excess ratio λ is set based on the engine speed and the total fuel injection amount. The threshold of the air excess ratio λ is set higher as the engine speed is reduced and the total fuel injection amount is increased, and the threshold is set lower within a range of λ≧1 as the engine speed is increased and the total fuel injection amount is reduced. Moreover, when the engine speed is higher than a predetermined engine speed indicated by the one-dot chain line in FIG. 7, the threshold of the air excess ratio λ is set to a predetermined value regardless of the total fuel injection amount. Note that, the predetermined value is a small value. Comparing the air excess ratio λ with the threshold corresponds to determining a state of the amount of exhaust gas introduced by the high-pressure EGR system 51 and/or the low-pressure EGR system 52, and the air excess ratio λ being smaller than the threshold means that the amount of the exhaust gas introduced into the cylinder 11 is more than a required amount for the operating state of the engine 10.

If the result of the determination at S5 is negative, S5 is repeated, and if the result of the determination at S5 is positive, the flow shifts to S6.

At S6, whether the operating state of the engine 10 is within the high engine load range is determined. The phrase “high engine load part” used here indicates the high engine load range higher than the straight dashed line in the map of FIG. 2. If the result of the determination at S6 is positive (i.e., within the high engine load part), the flow shifts to S7. On the other hand, if the result of the determination at S6 is negative (i.e., within the low engine load part), the flow shifts to S10.

At each of S7 to S12, the setting of the after injection is performed. First, at S7, to which the flow shifts after it is determined to be within the high engine load part, the close after injection set is selected as the injection mode of the after injection. In other words, the after injection timing is set to the relatively advanced timing (a predetermined injection timing), and the fuel injection amount is set to be relatively small (a predetermined injection amount). Following S7, at S8, a correction based on the engine speed NE and a correction based on the air excess ratio λ are performed on the after injection amount which was set at S7.

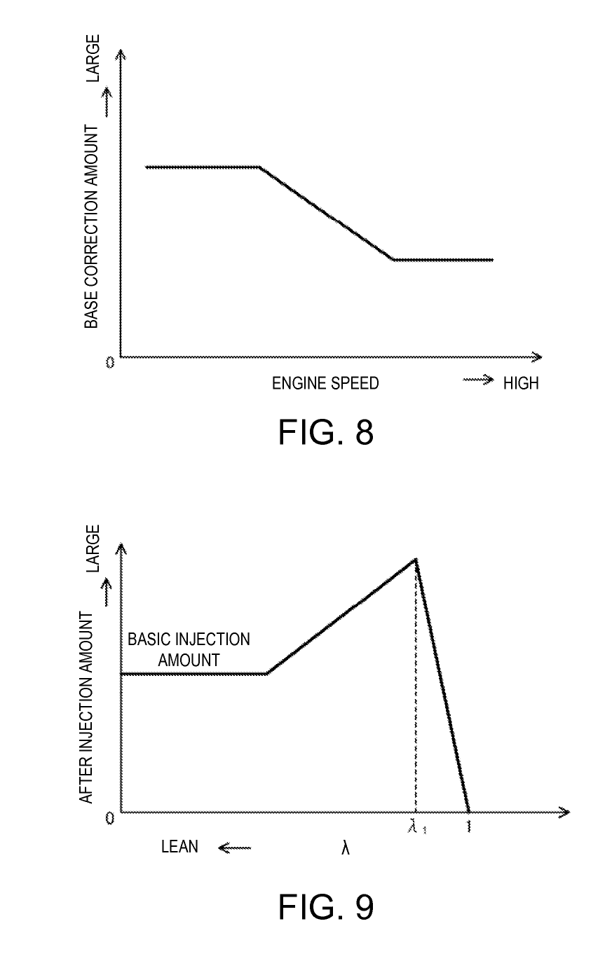

FIG. 8 is a chart illustrating a relationship between the engine speed and a correction amount of the fuel injection. The correction amount indicates a base correction amount to be added (increased) to the predetermined injection amount set at S7. When the engine speed is low, the base correction amount is large, whereas, when the engine speed is high, the base correction amount is low. When the engine speed is about medium, the base correction amount is changed according to the engine speed, and the base correction amount becomes smaller as the engine speed increases. The base correction amount has such a characteristic because the combustion by the after injection degrades if the after injection amount is excessively large since an actual period of time with respect to the change of the crank angle becomes short when the engine speed is high.

FIG. 9 is a chart illustrating a relationship between the air excess ratio λ and the after injection amount. The after injection amount used here indicates the after injection amount after being corrected based on the engine speed NE and the air excess ratio λ at S8. In other words, as illustrated in FIG. 8, even when the base correction amount is set according to the engine speed, depending on the air excess ratio λ, there are cases where the base correction amount is not added to the after injection amount (i.e., the correction of the injection amount is substantially not performed), cases where the correction amount to be added to the after injection amount is increased from the base correction amount, and cases where the after injection amount is reduced (including a case where the after injection amount is set to zero and so as not to be performed). The after injection amount is corrected by first correcting, based on the air excess ratio λ, the base correction amount which is set based on the map of FIG. 8 and then adding the corrected base correction amount to the predetermined injection amount. Note that, in a case where the base correction amount is corrected to be a minus value based on the air excess ratio λ, the predetermined injection amount is corrected by being reduced.

As illustrated in FIG. 9, when the air excess ratio λ is large, the after injection amount becomes the predetermined injection amount of the close after injection set which is set at S7. In other words, the correction of the injection amount is substantially not performed. This is because, due to the large air excess ratio λ, the soot generated by the main injection can be sufficiently reduced by the after injection with the predetermined injection amount.

When the air excess ratio λ is 1, since the amount of air inside the cylinder 11 is small, the combustion by the after injection cannot be performed sufficiently, and the soot reducing effect drops. Therefore, when the air excess ratio λ is 1, the after injection amount is set to zero so that the after injection is not performed. Thus, the unnecessary fuel injection is avoided and, as a result, degradation in fuel consumption and exhaust emission performance can be prevented.

Moreover, as the air excess ratio λ approaches 1, since the amount of air inside the cylinder 11 becomes smaller as described above, the after injection amount may simply be reduced. However, since the generation amount of soot by the combustion caused from the main injection increases as the air excess ratio λ approaches 1, the discharge amount of soot rather increases by simply reducing the after injection amount.

Therefore, with the engine 10, the after injection amount is increased according to the air excess ratio λ so as to reduce the soot with the after injection by utilizing air locally existing inside the cylinder 11. Specifically, the after injection amount is increased as the air excess ratio λ becomes larger and approaches a predetermined ratio λ₁ that is larger than 1 so that the after injection amount reaches a highest amount at the predetermined ratio λ₁. In this manner, the soot reducing effect by the after injection can be obtained as much as possible, and as a result, the discharge amount of soot can be reduced. For example, when the air excess ratio λ is the predetermined ratio λ₁, the after injection amount may be double the amount of the predetermined injection amount at highest.

On the other hand, when the air excess ratio λ exceeds the predetermined ratio λ₁, the amount of air inside the cylinder 11 becomes small, and not only the soot reducing effect by the after injection cannot be obtained, but also soot may increase due to the combustion caused by the after injection. Therefore, after the air excess ratio λ exceeds the predetermined ratio λ₁, the after injection amount is reduced as the air excess ratio λ approaches 1, and as described above, when the air excess ratio λ is 1, the after injection amount is set to zero.

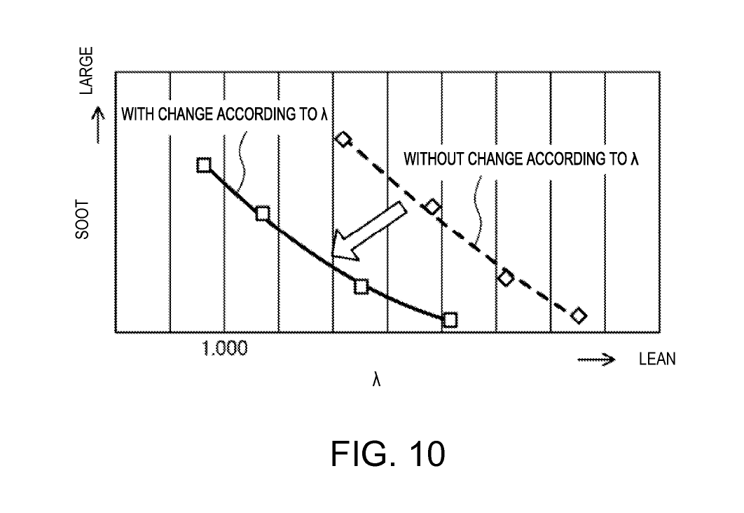

Thus, by changing the after injection amount according to the air excess ratio λ, for example as illustrated in FIG. 10, the discharge amount of soot can be reduced. FIG. 10 indicates a relationship between the air excess ratio λ and the discharge amount of soot. In FIG. 10, the dashed line indicates the discharge amount of soot when the after injection amount remains as the predetermined injection amount without being changed according to the air excess ratio λ, whereas the solid line indicates the discharge amount of soot when the after injection amount is changed according to the air excess ratio λ as illustrated in FIG. 9. According to FIG. 10, it can be understood that in either of the cases, even though the discharge amount of soot increases as the air excess ratio λ approaches 1, by changing the after injection amount, the discharge amount of soot can be reduced when compared with the same air excess ratio λ. As a result, in the case where the after injection amount is changed according to the air excess ratio λ, the discharge of soot can be suppressed until the air excess ratio λ reaches close to 1.

Return to the flow in FIG. 5, after the after injection amount is corrected at S8, subsequently at S9, the after injection timing is advanced according to the engine speed. In other words, in the state where the after injection timing is set to the relatively advanced predetermined timing due to the selection of the close after injection set, the after injection timing is slightly adjusted according to the engine speed.

While S7 to S9 is as described above, at S10, since the operating state of the engine is within the low engine load part, the far after injection set is selected as the injection mode of the after injection. In other words, the after injection timing is set to the relatively retarded timing (a predetermined injection timing), and the fuel injection amount is set to be relatively large (a predetermined injection amount). Following S10, at S11, similar to S8, the correction based on the engine speed NE and the correction based on the air excess ratio λ are performed on the predetermined injection amount of the after injection which is set at S10 (see FIGS. 8 and 9). Note that, although the map relating to the correction when the close after injection set is selected is different from the map relating to the correction when the far after injection set is selected, the tendency is the same. Moreover, at S12, similar to S9, the after injection timing is advanced (slightly adjusted) according to the engine speed.

After the injection amount and injection timing of the after injection are set at S7 to S12 as above, at S13, the injection amount of the preceding injection is changed according to the set after injection amount. Specifically, at S7 to S12, when the after injection amount is changed, the injection amount of the preceding injection (including the pilot injection and the pre-injection) is changed to compensate the change of the after injection amount. In this manner, the after injection amount can be changed while maintaining the total injection amount set at S2 and the main injection amount which is set at S3 fixed. By maintaining the main injection amount fixed, a change of the torque can be avoided. Moreover, since the injection amount of the preceding injection is significantly larger than the after injection amount, even if the injection amount of the preceding injection is changed corresponding to the change of the after injection amount, the change rate is comparatively small. There is also an advantage that even though the preceding injection contributes in igniting the mixture gas, the influence on the ignitability when the injection amount of the preceding injection is changed is small as a result.

When the injection amount of the preceding injection is set as above, at S14, the fuel injections are performed and the flow returns to the start.

During the acceleration transition of the engine system 1 in which at least the low-pressure EGR system 52 may be operated while the turbocharging system 6 is operated, by switching between the close after injection set and the far after injection set according to the engine load as above, within the high engine load part, the combustion caused by the after injection performed at the timing close to the main injection can be stabilized, and the large amount of soot generated by the main injection can be reduced and the discharge amount of soot can be reduced, and within the low engine load part, by the after injection performed at the timing far apart the main injection, the generation of soot by the after injection is suppressed and the discharge amount of soot can be reduced.

Moreover, within both of the high engine load part where the close after injection set is selected and the low engine load part where the far after injection set is selected, by correcting the injection amount and/or injection timing of the after injection according to the engine speed and/or the air excess ratio, the discharge amount of soot can be reduced more.

Note that, in the above description, the selection between the close after injection set and the far after injection set is performed only during the acceleration transition; however, also during a normal operation of the engine system 1, the selection between the close after injection set and the far after injection set may be performed according to the engine load.

Moreover, with the engine of this embodiment, the turbocharging system 6 is configured with the so-called two-stage turbochargers having the large turbocharger and the small turbocharger; however, alternatively, the turbocharging system 6 may be configured with a single turbocharger having a single turbine and a single compressor. Moreover, regardless of being the single turbocharger or the two-stage turbochargers, the turbocharger may be a VGT with variable vanes.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

### DESCRIPTION OF REFERENCE CHARACTERS

10 Engine
100 Control Unit
11 Cylinder
21 Injector
30 Intake Passage
40 Exhaust Passage
52 Low-pressure EGR System
6 Turbocharging System
611 Large Compressor
612 Large Turbine
621 Small Compressor
622 Small Turbine

What is claimed is:

1. A fuel injection control device of a diesel engine, comprising:
an engine body having a cylinder;
a fuel injection valve for injecting a fuel into the cylinder;
a turbocharger having a turbine disposed in an exhaust passage of the engine body and a compressor disposed in an intake passage of the engine body;
a low-pressure EGR system for introducing exhaust gas extracted from a position of the exhaust passage downstream of the turbocharger, into a position of the intake passage upstream of the turbocharger; and
a controller for operating the engine body by controlling an injection mode of the fuel through the fuel injection valve, and the circulation of the exhaust gas through the low-pressure EGR system,
wherein when an operation state of the engine body is within a predetermined high engine-load operating range where turbocharging by the turbocharger is performed, the controller operates the low-pressure EGR system and controls the fuel injection valve to perform a main injection and a post injection after the main injection, and
wherein within the operating range where the post injection is performed, the controller performs a post-injection switching control in which when the engine load is lower than a predetermined load, an injection amount of the post injection is set to a first injection amount and an injection timing of the post injection is set to a first timing, and when the engine load is higher than the predetermined load, the injection amount of the post injection is set to a second injection amount that is less than the first injection amount, and the injection timing of the post injection is set to a second timing that is advanced than the first timing.

2. The device of claim 1, wherein in the post-injection switching control, the controller adjusts the injection amount of the post injection according to an air excess ratio of mixture gas inside the cylinder, and
wherein when the air excess ratio is higher than a predetermined value that is higher than 1, the injection amount of the post injection is adjusted by being increased as the air excess ratio approaches the predetermined value so that the injection amount reaches its highest value when the air excess ratio is at the predetermined value, and when the air excess ratio is lower than the predetermined value, the injection amount of the post injection is adjusted by being reduced as the air excess ratio approaches 1 so that the injection amount becomes zero when the air excess ratio is 1.

3. The device of claim 2, wherein in the post-injection switching control, the controller performs a pre-injection before the main injection, and
wherein the controller changes an injection amount of the pre-injection corresponding to the change of the injection amount of the post injection.

4. The device of claim 1, wherein the controller performs the post-injection switching control when the engine body is in an acceleration transition.

5. The device of claim 2, wherein the controller performs the post-injection switching control when the engine body is in an acceleration transition.

6. The device of claim 3, wherein the controller performs the post-injection switching control when the engine body is in an acceleration transition.

7. The device of claim 4, wherein the controller performs the post-injection switching control when the engine body is during the acceleration transition and the air excess ratio of the mixture gas inside the cylinder is lower than the predetermined value.

8. The device of claim 5, wherein the controller performs the post-injection switching control when the engine body is during the acceleration transition and the air excess ratio of the mixture gas inside the cylinder is lower than the predetermined value.

9. The device of claim 6, wherein the controller performs the post-injection switching control when the engine body is during the acceleration transition and the air excess ratio of the mixture gas inside the cylinder is lower than the predetermined value.
